(19) United States
(12) Patent Application Publication
(10) Pub. No.: US 2025/0212152 A1
(43) Pub. Date: Jun. 26, 2025

(54) SEAMLESS USER EQUIPMENT (UE) CONTEXT RECOVERY

(71) Applicant: Apple Inc., Cupertino, CA (US)

(72) Inventors: Vivek G. Gupta, San Jose, CA (US); Sridhar Prakasam, Fremont, CA (US); Sudeep Manithara Vamanan, Uttenreuth, Bavaria-Bayern (DE); Haijing Hu, Los Gatos (CA); Krisztian Kiss, Rancho Santa Fe, CA (US); Rohit R Matolia, Bangalore, Karnataka (IN); Vijay Venkataraman, San Jose, CA (US); Alosious Pradeep Prabhakar, Singapore (SG); ChunLei Lin, Pudong, Shanghai (HK)

(21) Appl. No.: 18/849,025

(22) PCT Filed: Mar. 29, 2022
(86) PCT No.: PCT/CN2022/083594

§ 371 Date: Sep. 20, 2024

(51) Int. Cl. H04W 60/06

(52) U.S. Cl. CPC H04W 60/06

(57) ABSTRACT

A user equipment (UE) includes a transceiver and a processor. The processor is configured to determine to perform an operation during an unavailability period of the UE; transmit to a 3rd Generation Partnership Project (3GPP) network, in response to determining to perform the operation and via the transceiver, a first message requesting an acceptance of the unavailability period, the first message including an estimated duration of the unavailability period; and receive from the 3GPP network, via the transceiver, a second message indicating the acceptance of the unavailability period or a rejection of the unavailability period.

### TECHNICAL FIELD

This application relates generally to wireless communication systems, including systems, methods, and apparatus for assigning a wireless communication device (e.g., a user equipment (UE)) to a paging subgroup.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example flow diagram for seamless UE context recovery following an unavailability period of the UE.

FIGS. 2-4 illustrate a first set of example embodiments, of the flow diagram shown in FIG. 1, for a UE that de-registers from a 3GPP network during an unavailability period.

FIGS. 5-7 illustrate a second set of example embodiments, of the flow diagram shown in FIG. 1, for a UE that does not de-register from a 3GPP network during an unavailability period.

FIG. 8 illustrates an example flow diagram for seamless UE context recovery when a 3GPP network initiates de-registration of a UE.

FIGS. 9A and 9B illustrate an example flow diagram for seamless UE context recovery for multiple UEs.

FIG. 10 shows an example method of wireless communication by a UE, which method may be used to preserve a context of the UE during an unavailability period of the UE.

FIG. 11 shows an example method of communication by a network server, which method may be used to preserve a context of a UE during an unavailability period of the UE.

FIG. 12 shows another example method of wireless communication by a UE, which method may be used to preserve a context of the UE during an unavailability period of the UE.

FIG. 13 illustrates an example architecture of a wireless communication system, according to embodiments disclosed herein.

FIG. 14 illustrates a system for performing signaling between a wireless device and one or more network devices, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with a network. Therefore, the UE as described herein is used to represent any appropriate electronic device.

At times, a UE may need to perform an operation that makes the UE unavailable to some or all aspects of a 3GPP network (e.g., unavailable to a CN or Application Function (AF)). Operations that may make a UE unavailable to some or all aspects of a 3GPP network include, for example, the application of security patches, software upgrades, silent resets and device reboots, and so on. A UE may sometimes perform these operations in response to user input, but the initiation of some or all of these operations is often left to UE implementation.

The duration of a UE's unavailability period (i.e., the time during which the UE is unavailable to some or all aspects of a 3GPP network) can range from several seconds to several minutes. When a UE becomes unavailable without prior knowledge of a CN or AF, the unavailability can impact critical operations that may need to be performed on or by an application server. For example, a CN or AF may require input from an Internet of Things (IoT) device, or an ultra-reliable low latency communication (URLLC) between an AF and a device (e.g., an industrial, factory, or medical device) that may require an immediate response from the device. As a result, it would be useful for a UE and CN or AF to coordinate the timing of an unavailability period for the UE, so that critical operations may be appropriately handled and/or so the network can handle the unavailability of the UE gracefully.

In some cases, a CN or AF may know about an event that is going to require an unavailability period for a UE. For example, the UE may download a software update that the CN or AF knows the UE needs to install. However, even in these cases, the timing of the install may be left to UE implementation, and the UE may delay the install for various reasons, such as low storage capacity or a low battery level.

The present disclosure describes systems, methods, apparatus, and devices that enable a network (e.g., a 5G System (5GS)) to determine the timing of an unavailability period for a UE.

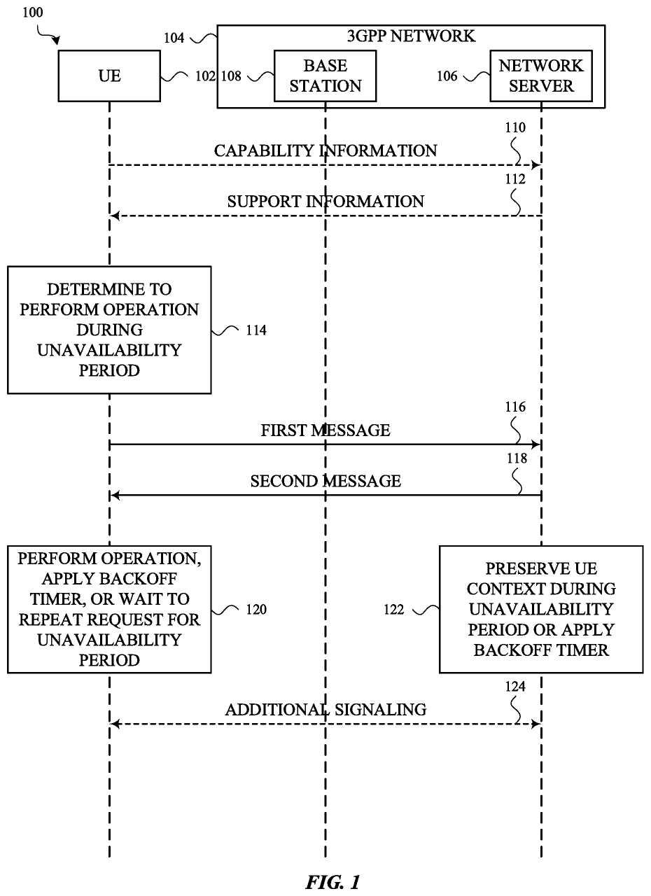

FIG. 1 illustrates an example flow diagram 100 for seamless UE context recovery following an unavailability period of the UE. The messages shown in FIG. 1 may be transmitted between a UE 102 and a 3GPP network 104. In some cases, the messages may be non-access stratum (NAS) messages that are transmitted between a UE 102 and a network server 106 (e.g., a network server hosting an Access and Mobility Management Function (AMF) of a CN) via a base station 108 (e.g., an eNB or gNB). The operations performed by the UE 102 may be performed by a processor of the UE 102, and the transmissions and receptions of the UE 102 may be made via a transceiver of the UE 102. The operations performed by the 3GPP network 104 may be performed by a processor of the network server 106, and the transmissions and receptions of the network server 106 may be made via a communications interface of the network server 106.

At 110, the UE 102 may optionally transmit capability information to the 3GPP network 104 (e.g., to the network server 106). The capability information may include information pertaining to the UE's capability to determine (e.g., schedule) an unavailability period of the UE 102.

At 112, the 3GPP network 104 (e.g., the network server 106) may optionally transmit support (or lack of support) information to the UE 102. The support information may indicate whether the 3GPP network 104 supports the UE's capability to determine the unavailability period of the UE 102. If the 3GPP network 104 supports the UE's capability to determine the unavailability period, the 3GPP network 104 may be able to preserve a context of the UE 102 during a period when the UE 102 is unavailable to the 3GPP network 104. If the 3GPP network 104 does not support the UE's capability to determine the unavailability period, the 3GPP network 104 may be unable to preserve a context of the UE 102 during a period when the UE 102 is unavailable to the 3GPP network 104.

At 114, the UE 102 may determine to perform an operation during an unavailability period of the UE 102. The operation may include, for example, one or more of a silent reset of a modem, a security patch update, an OS upgrade, a modem software update, a device reboot upon a modem setting change (e.g., via OMA-DM), another type of firmware, software, or binary update, and so on.

At 116, the UE 102 may transmit to the 3GPP network 104 (e.g., to the network server 106), in response to determining to perform the operation at 114, a first message requesting an acceptance of the unavailability period. The first message may include an estimated duration of the unavailability period (e.g., a duration in seconds or some other time unit). When capability information is exchanged at 110 and 112, the first message may only be transmitted if the 3GPP network 104 indicates that it supports the UE's capability to determine an unavailability period.

At 118, the 3GPP network 104 (e.g., the network server 106) may transmit to the UE 102, in response to receiving the first message at 116, a second message indicating either an acceptance of the unavailability period or a rejection of the unavailability period. When the 3GPP network 104 accepts the unavailability period, the UE 102 may continue its preparation for the unavailability period and begin the unavailability period. Alternatively, the second message may reference a backoff timer, in which case the UE 102 may not begin the unavailability period until after the backoff timer has been applied. A length of the backoff timer may in some cases be included in the second message. In other cases, the second message may indicate that a backoff timer having a predetermined duration should be applied. While the backoff timer is running, the UE 102 may behave normally and may communicate with the 3GPP network 104.

At 120, and in response to receiving an acceptance of the unavailability period at 116, the UE 102 may begin the unavailability period and perform the operation that it previously determined to perform at 114. However, if the acceptance of the unavailability period referenced a backoff timer, the UE may first apply the backoff timer and then begin the unavailability period and perform the operation. If the UE 102 instead receives a rejection of the unavailability period at 118, the UE 102 may not begin the unavailability period, and may transmit a new request for acceptance of an unavailability period at a later time. In some cases, a rejection of an unavailability period, transmitted at 118, may reference a backoff timer that indicates how long the UE 102 has to wait before transmitting a new request for acceptance of an unavailability period.

At 122, and contemporaneously with the operations performed at 120, the 3GPP network 104 (e.g., the network server 106) may apply the backoff timer and/or a timer for the estimated duration of the unavailability period (that is, assuming that the 3GPP network 104 transmitted an acceptance of the unavailability period to the UE 102). While applying one or both of the timers, the 3GPP network 104 may preserve a context of the UE 102. For example, the 3GPP network 104 (e.g., the network server 106) may buffer or save incoming requests (e.g., pages) for the UE 202, and so on. After (or within) application of one or both of the timers, the 3GPP network 104 may expect the UE 102 to transmit (and may monitor for at 124) a message (e.g., a REGISTRATION REQUEST message or a SERVICE REQUEST message) indicating that the UE 102 has finished the operation it intended to perform during the unavailability period. If such a message is received by the 3GPP network 104 (e.g., by the network server 106) within the unavailability period, or within a predetermined period of time after the unavailability period, the UE 102 may seamlessly recover its context with the 3GPP network 104. If such a message is not received by the 3GPP network 104 within the unavailability period, or within a predetermined period of time after the unavailability period, the 3GPP network 104 may discard the UE's context.

Other signaling or operations may also be performed at, or after, 124. Other signaling or operations may also be performed while a backoff timer, if any, is being applied at 120.

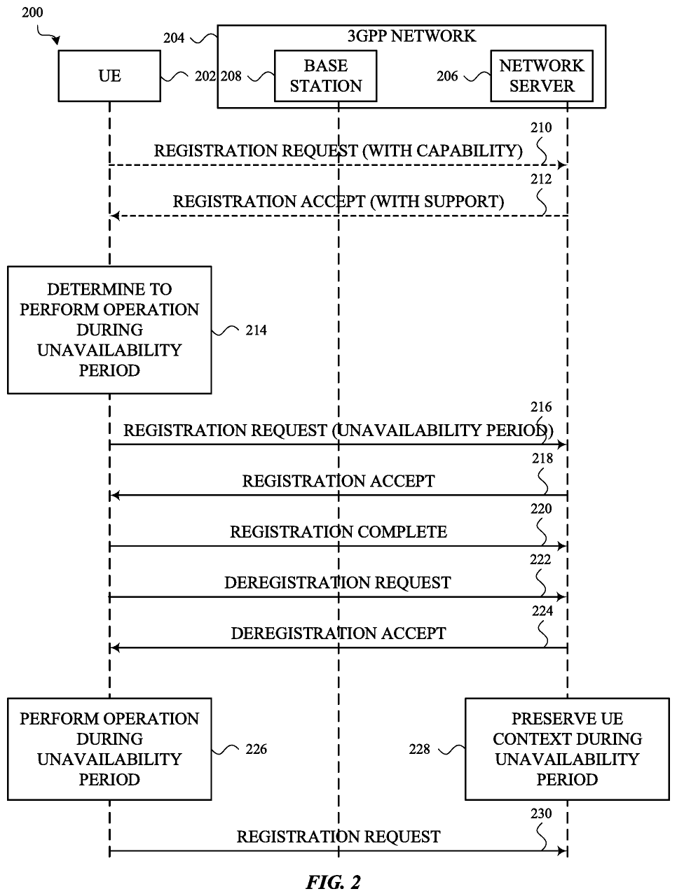

FIGS. 2-4 illustrate a first set of example embodiments, of the flow diagram shown in FIG. 1, for a UE 202 that de-registers from a 3GPP network 204 during an unavailability period. The messages shown in FIGS. 2-4 may in some cases be transmitted as NAS messages, and may be transmitted between the UE 202 and a network server 206 of the 3GPP network 204 (e.g., a network server hosting an AMF of a CN). The messages may be transmitted between the UE 202 and the network server 206 via a base station 208 (e.g., an eNB or gNB). The operations performed by the UE 202 may be performed by a processor of the UE 202, and the transmissions and receptions of the UE 202 may be made via a transceiver of the UE 202. The operations performed by the 3GPP network 204 may be performed by a processor of the network server 206, and the transmissions and receptions of the network server 206 may be made via a communications interface of the network server 206.

FIG. 2 illustrates an example flow diagram 200 for a UE 202 that de-registers from a 3GPP network 204 after the UE's unavailability period is accepted by the 3GPP network 204.

At 210, the UE 202 may optionally transmit capability information to the 3GPP network 204 (e.g., to the network server 206). The capability information may be transmitted in a 5G mobility management (5GMM) capability information element (IE) of a REGISTRATION REQUEST message. The capability information may include an indication of a capability to determine an unavailability period of the UE 202.

At 212, the 3GPP network 204 (e.g., the network server 206) may optionally transmit support (or lack of support) information to the UE 202. The support information may be transmitted in a 5GS network feature support IE of a REGISTRATION ACCEPT message. The support information may include an indication of support for the capability to determine the unavailability period of the UE 202. If the 3GPP network 204 supports the UE's capability to determine the unavailability period, the 3GPP network 204 may be able to preserve a context of the UE 202 during a period when the UE 202 is unavailable to the 3GPP network 204. If the 3GPP network 204 does not support the UE's capability to determine the unavailability period, the 3GPP network 204 may be unable to preserve a context of the UE 202 during a period when the UE 202 is unavailable to the 3GPP network 204.

At 214, the UE 202 may determine to perform an operation during an unavailability period of the UE 202. The operation may include, for example, any of the operations described with reference to FIG. 1.

At 216, the UE 202 may transmit to the 3GPP network 204 (e.g., to the network server 206), in response to determining to perform the operation at 214, a first message requesting an acceptance of the unavailability period. The first message may be a REGISTRATION REQUEST message, such as a REGISTRATION REQUEST message for mobility and periodic registration update. The first message may include an estimated duration of the unavailability period (e.g., a duration in seconds or some other time unit). The estimated duration of the unavailability period may be transmitted in an Unavailable Time IE of the REGISTRATION REQUEST message. When capability information is exchanged at 210 and 212, the first message may only be transmitted if the 3GPP network 204 indicates that it supports the UE's capability to determine an unavailability period.

At 218, the 3GPP network 204 (e.g., the network server 206) may transmit to the UE 202, in response to receiving the first message at 214, a second message indicating an acceptance of the unavailability period. The second message may be a REGISTRATION ACCEPT message and may include a 5GS additional request result IE indicating the acceptance of the unavailability period (e.g., an “Unavailable time is accepted” indication).

At 220, and in response to receiving the REGISTRATION ACCEPT message, the UE 202 may transmit a REGISTRATION COMPLETE message to the 3GPP network 204 (e.g., to the network server 206).

At 222, and in response to the unavailability period being accepted, the UE 202 may de-register with the 3GPP network 204. The de-registration may be initiated by transmitting a DEREGISTRATION REQUEST message to the 3GPP network 204 (e.g., to the network server 206). In some embodiments, the DEREGISTRATION REQUEST message may include a cause or a type of de-registration. For example, the UE 202 may indicate that the cause of de-registration is a “software update” (i.e., type: software update). At 224, the 3GPP network 204 may acknowledge the DEREGISTRATION REQUEST message by transmitting a DEREGISTRATION ACCEPT message.

Following receipt of the DEREGISTRATION ACCEPT message, the UE 202 may begin the unavailability period at 226 and perform the operation that it previously determined to perform at 214.

At 228, and contemporaneously with the operations performed at 226, the 3GPP network 204 (e.g., the network server 206) may apply a timer for the estimated duration of the unavailability period. While applying the timer, the 3GPP network 204 may preserve a context of the UE 202 (e.g., stop data transmission to the UE 502, discard pending data, hold pages, and so on). After (or within) application of the timer, the 3GPP network 204 may expect the UE 202 to transmit (and may monitor for at 230) a REGISTRATION REQUEST message indicating that the UE 202 has finished the operation it intended to perform during the unavailability period. If such a message is received by the 3GPP network 204 (e.g., by the network server 206) within the unavailability period, or within a predetermined period of time after the unavailability period, the UE 202 may seamlessly recover its context with the 3GPP network 204. If such a message is not received by the 3GPP network 204 within the unavailability period, or within a predetermined period of time after the unavailability period, the 3GPP network 204 may discard the UE's context.

Other signaling or operations may also be performed after 230. The other signaling may include, for example, a REGISTRATION ACCEPT message transmitted by the 3GPP network 204 in response to the REGISTRATION REQUEST message transmitted at 230.

Although FIG. 2 illustrates a flow diagram 200 in which the UE's unavailability period is accepted by the 3GPP network 204, the UE's unavailability period may alternatively be rejected by the 3GPP network 204. In this alternative scenario, and at 218, the 3GPP network 204 (e.g., the network server 206) may transmit to the UE 202, in response to receiving the first message at 216, a second message indicating a rejection of the unavailability period. The second message may be a REGISTRATION ACCEPT message and may include a 5GS additional request result IE indicating the rejection of the unavailability period (e.g., an “Unavailable time is rejected” indication). In such a scenario, the UE 202 may transmit to the 3GPP network 204 (e.g., to the network server 206) a third message requesting an acceptance of the unavailability period (i.e., a repeated request). The 3GPP network 204 may then transmit a fourth message, indicating whether the unavailability period is accepted or rejected. In some cases, the second message (i.e., the message including the rejection of the unavailability period) may reference a backoff timer that indicates how long the UE 202 must wait before once again requesting an acceptance of the unavailability period.

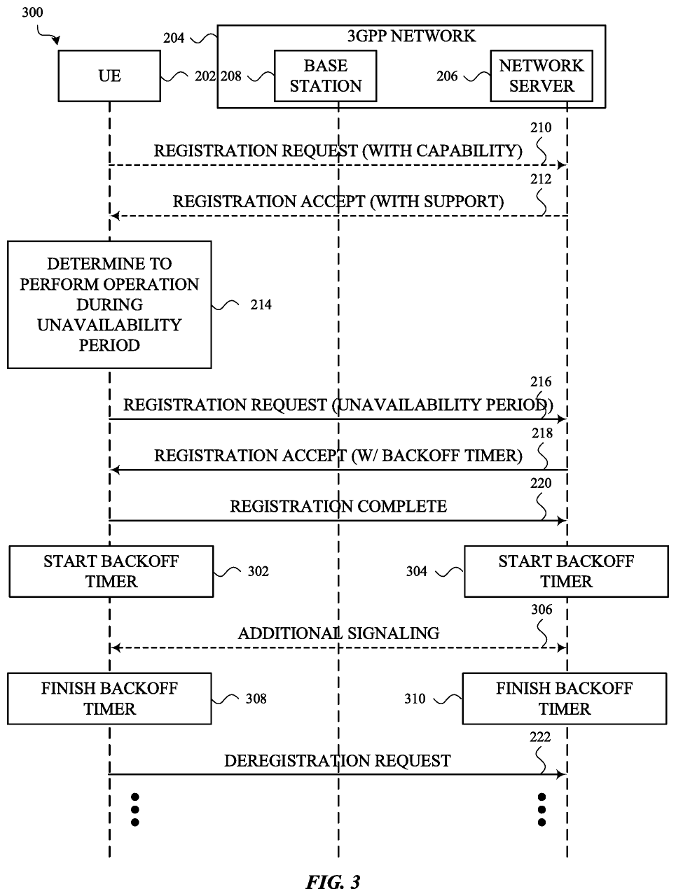

FIG. 3 illustrates an example flow diagram 300 for a UE 202 that de-registers from a 3GPP network 204 after the UE's unavailability period is accepted by the 3GPP network 204, and after the UE 202 applies a backoff timer.

The operations at 210-220 may be similar to those described with reference to FIG. 2. However, at 218, the 3GPP network 204 may transmit a second message that includes an acceptance of the unavailability period and also references a backoff timer. A length of the backoff timer may in some cases be included in the second message. In other cases, the second message may indicate that a backoff timer having a predetermined duration should be applied.

At 302 and 304, and in response to the unavailability period being accepted, the UE 202 and 3GPP network 204 (e.g., the network server 206) may start the backoff timer. While the backoff timer is running, and at 306, the UE 202 may optionally participate in other signaling or operations with the 3GPP network 204 (e.g., downloads, paging, a configuration update, and so on), on the initiative of the UE 202 or in response to messages received from the 3GPP network 204 (e.g., from the base station 208 or the network server 206).

At 308 and 310, the UE 202 and 3GPP network 204 may finish the backoff timer. Subsequently, and at 222, the UE 202 may de-register with the 3GPP network 204. The de-registration may be initiated by transmitting a DEREGISTRATION REQUEST message to the 3GPP network 204 (e.g., to the network server 206). The UE 202 and 3GPP network 204 may then continue with operations 224, 226, 228, and 230, as described with reference to FIG. 2.

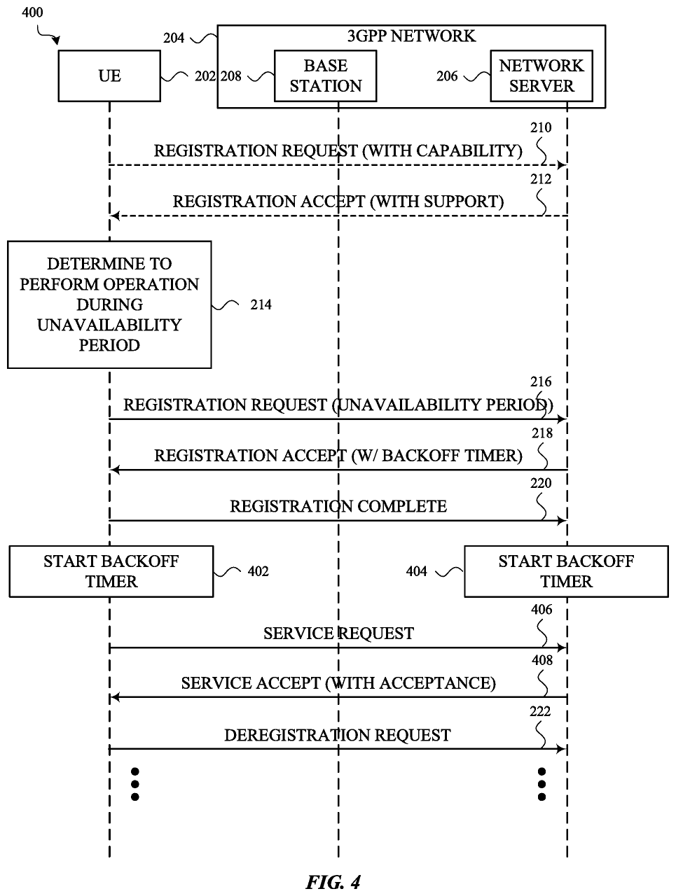

FIG. 4 illustrates an example flow diagram 400 for a UE 202 that de-registers from a 3GPP network 204 after the UE's unavailability period is accepted by the 3GPP network 204, and while the UE 202 is applying a backoff timer.

The operations at 210-220 may be similar to those described with reference to FIG. 2. However, at 218, the 3GPP network 204 may transmit a second message that includes an acceptance of the unavailability period and also references a backoff timer. A length of the backoff timer may in some cases be included in the second message. In other cases, the second message may indicate that a backoff timer having a predetermined duration should be applied.

At 402 and 404, and in response to the unavailability period being accepted, the UE 202 and 3GPP network 204 (e.g., the network server 206) may start the backoff timer. While the backoff timer is running, the UE 202 may optionally participate in other signaling or operations with the 3GPP network 204 (e.g., downloads, paging, a configuration update, and so on), on the initiative of the UE 202 or in response to messages received from the 3GPP network 204 (e.g., from the base station 208 or the network server 206).

At 406, and in the course of participating in other signaling or operations with the 3GPP network 204 while applying the backoff timer (e.g., in response to a page), the UE 202 may transmit a third message (e.g., a SERVICE REQUEST message) to the 3GPP network 204 (e.g., to the network server 206). If conditions of the 3GPP network 204 have changed since the REGISTRATION ACCEPT message was transmitted 218, and it is now acceptable for the UE 202 to begin its unavailability period, the 3GPP network 204 (e.g., the network server 206) may include, in a response to the third message transmitted at 408 (e.g., in a fourth message, such as a SERVICE ACCEPT message), an acceptance of the unavailability period. In some cases, the fourth message may be a REGISTRATION ACCEPT message including a 5GS additional request result IE, which IE may indicate the acceptance of the unavailability period (e.g., an “Unavailable time is accepted” indication).

At 222, the UE 202 may de-register with the 3GPP network 204 without finishing the backoff timer. The de-registration may be initiated by transmitting a DEREGISTRATION REQUEST message to the 3GPP network 204 (e.g., to the network server 206). The UE 202 and 3GPP network 204 may then continue with operations 224, 226, 228, and 230, as described with reference to FIG. 2. Alternatively, the operations at 406 and/or 222 may be replaced by a network-initiated transmission of a DEREGISTRATION REQUEST message, in which the 3GPP network 204 asks that the UE 202 de-register and begin the unavailability period.

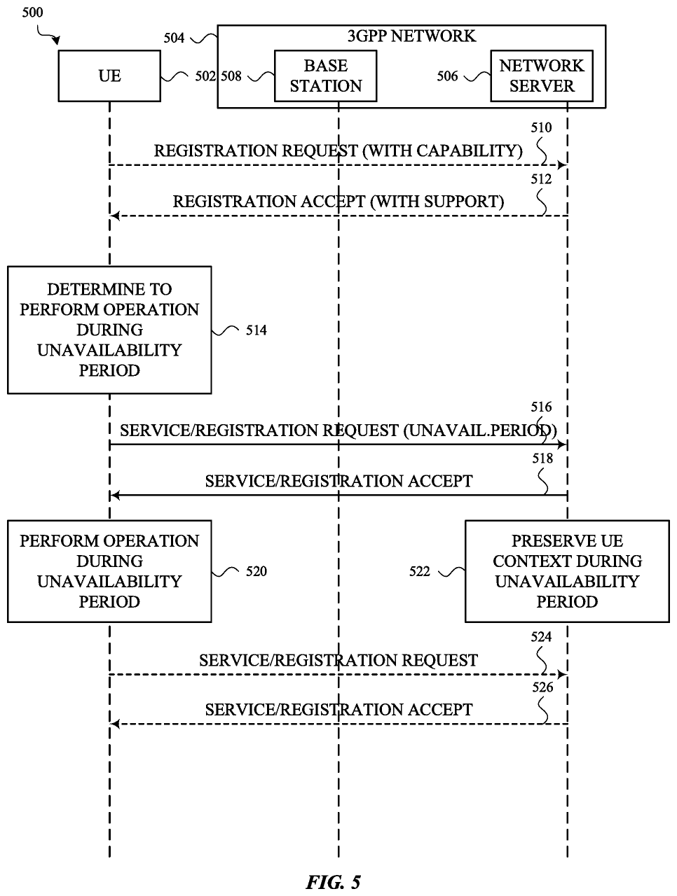

FIGS. 5-7 illustrate a second set of example embodiments, of the flow diagram shown in FIG. 1, for a UE 502 that does not de-register from a 3GPP network 504 during an unavailability period. The messages shown in FIGS. 5-7 may in some cases be transmitted as NAS messages, and may be transmitted between the UE 502 and a network server 506 of the 3GPP network 504 (e.g., a network server hosting an AMF of a CN). The messages may be transmitted between the UE 502 and the network server 506 via a base station 508 (e.g., an eNB or gNB). The operations performed by the UE 502 may be performed by a processor of the UE 502, and the transmissions and receptions of the UE 502 may be made via a transceiver of the UE 502. The operations performed by the 3GPP network 504 may be performed by a processor of the network server 506, and the transmissions and receptions of the network server 506 may be made via a communications interface of the network server 506.

The embodiments described with reference to FIGS. 5-7 re-use Multiple Universal Subscriber Identity Modules (MUSIM) features to indicate a UE's unavailability period to a 3GPP network. The re-used MUSIM features may include, for example, the Connection Release feature described in 3GPP Technical Specification (TS) 23.501 clause 5.38.2 and/or the Paging Restriction described in 3GPP TS 23.501 clause 5.38.5. The embodiments described with reference to FIGS. 5-7 may also introduce a new feature—an Expected Leaving Duration feature—which can be used to indicate an estimated duration of an unavailability period. The Expected Leaving Duration feature can only be used in combination with the Connection Release feature.

FIG. 5 illustrates an example flow diagram 500. At 510, the UE 502 may optionally transmit capability information to the 3GPP network 504 (e.g., to the network server 506). The capability information may be transmitted in a 5GMM core network capability IE of a REGISTRATION REQUEST message, for a particular Universal Subscriber Identity Module (USIM) of the UE 502 and for a particular Public Land Mobile Network (PLMN). The capability information may include an indication of support for a MUSIM Connection Release, a MUSIM Paging Restriction, and an Expected Leaving Duration.

At 512, the 3GPP network 504 (e.g., the network server 506) may optionally transmit support (or lack of support) information to the UE 502. The support information may be transmitted in a 5GS network feature support IE of a REGISTRATION ACCEPT message. The support information may include an indication of support for MUSIM Connection Release, MUSIM Paging Restriction, and Expected Leaving Duration (i.e., an estimated duration of the unavailability period), and may be based on network capability and network preference (e.g., based on local network policy). An indication of support for Paging Restriction may only be provided if Connection Release is supported. Similarly, an indication of support for Expected Leaving Duration may only be provided if Connection Release is supported. If the 3GPP network 504 supports at least the MUSIM Connection Release and Expected Leaving Duration (and preferably, the MUSIM Paging Restriction), the 3GPP network 504 may be able to preserve a context of the UE 502 during a period when the UE 502 is unavailable to the 3GPP network 504. If the 3GPP network 504 does not support the MUSIM Connection Release or Expected Leaving Duration, the 3GPP network 504 may be unable to preserve a context of the UE 502 during a period when the UE 502 is unavailable to the 3GPP network 504.

At 514, the UE 502 may determine to perform an operation during an unavailability period of the UE 502. The operation may include, for example, any of the operations described with reference to FIG. 1.

At 516, the UE 502 may transmit to the 3GPP network 504 (e.g., to the network server 506), in response to determining to perform the operation at 514, a first message including a Release Request indication, a Paging Restriction indication (indicating that all paging is restricted), and an Expected Leaving Duration. The first message may be a REGISTRATION REQUEST message, such as a REGISTRATION REQUEST message for mobility and periodic registration update, or a SERVICE REQUEST message. The Expected Leaving Duration may indicate an estimated duration of the unavailability period (e.g., a duration in seconds or some other time unit). When capability information is exchanged at 510 and 512, the first message may only be transmitted if the 3GPP network 504 indicates its support for at least the MUSIM Connection Request and the Expected Leaving Duration.

At 518, the 3GPP network 504 (e.g., the network server 506) may transmit to the UE 502, in response to receiving the first message at 514, a second message indicating an acceptance of the unavailability period. The second message may be a REGISTRATION ACCEPT message or a SERVICE ACCEPT message including a Release Request indication, Paging Restriction information, and an accepted value for the Expected Leaving Duration.

At 520, and in response to receiving the REGISTRATION ACCEPT message or the SERVICE ACCEPT message, the UE 502 may begin the unavailability period and perform the operation that it previously determined to perform at 514.

At 522, and contemporaneously with the operations performed at 520, the 3GPP network 504 (e.g., the network server 506) may apply a timer for the Expected Leaving Duration. While applying the timer, the 3GPP network 504 may preserve a context of the UE 502 (e.g., stop data transmission to the UE 502, discard pending data, hold pages, and so on). After (or within) application of the timer, the 3GPP network 504 may expect the UE 502 to transmit (and may monitor for at 524) a REGISTRATION REQUEST message or a SERVICE REQUEST message indicating that the UE 502 has finished the operation it intended to perform during the unavailability period. If such a message is received by the 3GPP network 504 (e.g., by the network server 506) within the unavailability period, or within a predetermined period of time after the unavailability period, the UE 502 may seamlessly recover its context with the 3GPP network 504. If such a message is not received by the 3GPP network 504 within the unavailability period, or within a predetermined period of time after the unavailability period, the 3GPP network 504 may discard the UE's context. Alternatively, the 3GPP network 504 may automatically attempt to resume communication with the UE 502 after the unavailability period, regardless of whether the UE 502 transmits a message during or after the unavailability period (e.g., NAS signaling may automatically resume).

Other signaling or operations may also be performed at after 524. The other signaling may include, for example, a REGISTRATION ACCEPT message or a SERVICE ACCEPT message, transmitted in response to the REGISTRATION REQUEST message or the SERVICE REQUEST message transmitted at 524.

Although FIG. 5 illustrates a flow diagram 500 in which the UE's unavailability period is accepted by the 3GPP network 504, the UE's unavailability period may alternatively be rejected by the 3GPP network 504. In this alternative scenario, and at 518, the 3GPP network 504 (e.g., the network server 506) may transmit to the UE 502, in response to receiving the first message at 516, a second message indicating a rejection of the unavailability period. The second message may be a REGISTRATION ACCEPT message or a SERVICE ACCEPT message indicating the rejection of the unavailability period. In such a scenario, the UE 502 may transmit to the 3GPP network 504 (e.g., to the network server 506) a third message requesting an acceptance of the unavailability period (i.e., a repeated request). The 3GPP network 504 may then transmit a fourth message, indicating whether the unavailability period is accepted or rejected. In some cases, the second message (i.e., the message including the rejection of the unavailability period) may reference a backoff timer that indicates how long the UE 502 must wait before once again requesting an acceptance of the unavailability period.

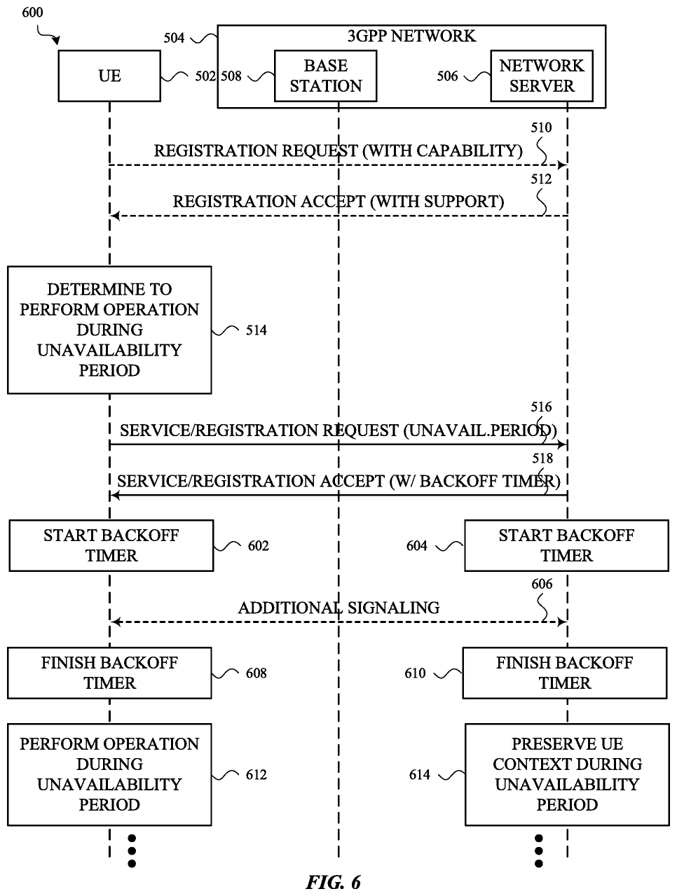

FIG. 6 illustrates an example flow diagram 600 for a UE 502 that receives an acceptance of the UE's unavailability period, but also receives a backoff timer.

The operations at 510-518 may be similar to those described with reference to FIG. 5. However, at 518, the 3GPP network 504 may transmit a second message that includes an acceptance of the unavailability period and also references a backoff timer. A length of the backoff timer may in some cases be included in the second message. In other cases, the second message may indicate that a backoff timer having a predetermined duration should be applied.

At 602 and 604, and in response to the unavailability period being accepted, the UE 502 and 3GPP network 504 (e.g., the network server 506) may start the backoff timer. While the backoff timer is running, and at 606, the UE 502 may optionally participate in other signaling or operations with the 3GPP network 504 (e.g., downloads, paging, a configuration update, and so on), on the initiative of the UE 502 or in response to messages received from the 3GPP network 504 (e.g., from the base station 508 or the network server 506).

At 608 and 610, the UE 502 and 3GPP network 504 may finish the backoff timer. Subsequently, and at 612, the UE 502 may begin the unavailability period and perform the operation that it previously determined to perform at 514. Contemporaneously, and at 614, the 3GPP network 504 (e.g., the network server 506) may apply a timer for the Expected Leaving Duration. The UE 502 and 3GPP network 504 may then continue with operations 524 and 526, as described with reference to FIG. 5.

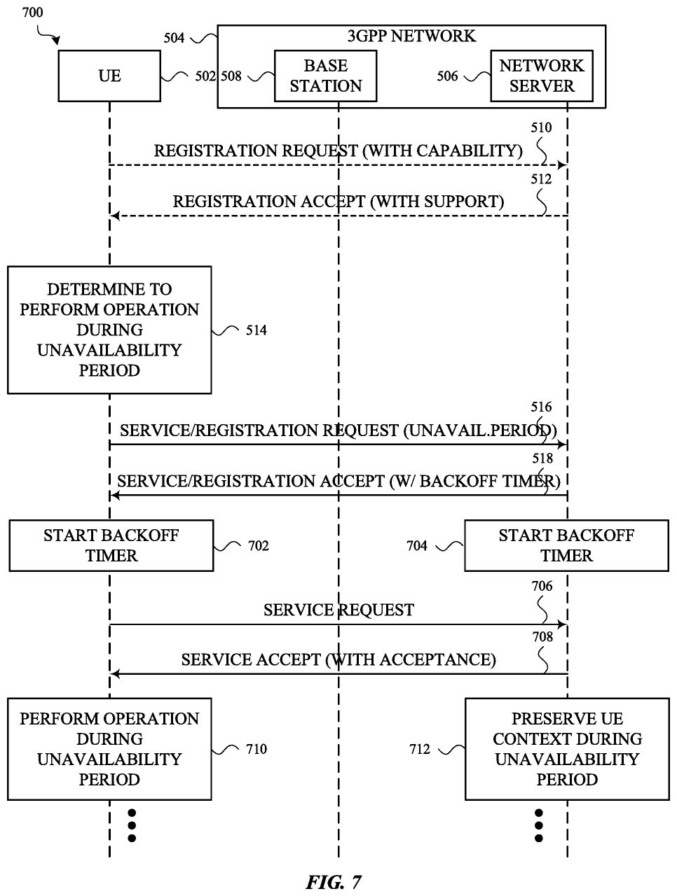

FIG. 7 illustrates another example flow diagram 700 for a UE 502 that receives an acceptance of the UE's unavailability period, but also receives a backoff timer.

The operations at 510-518 may be similar to those described with reference to FIG. 5. However, at 518, the 3GPP network 504 may transmit a second message that includes an acceptance of the unavailability period and also references a backoff timer. A length of the backoff timer may in some cases be included in the second message. In other cases, the second message may indicate that a backoff timer having a predetermined duration should be applied.

At 702 and 704, and in response to the unavailability period being accepted, the UE 502 and 3GPP network 504 (e.g., the network server 506) may start the backoff timer. While the backoff timer is running, the UE 502 may optionally participate in other signaling or operations with the 3GPP network 504 (e.g., downloads, paging, a configuration update, and so on), on the initiative of the UE 502 or in response to messages received from the 3GPP network 504 (e.g., from the base station 508 or the network server 506).

At 706, and in the course of participating in other signaling or operations with the 3GPP network 504 while applying the backoff timer (e.g., in response to a page), the UE 502 may transmit a third message (e.g., a SERVICE REQUEST message) to the 3GPP network 504 (e.g., to the network server 506). If conditions of the 3GPP network 504 have changed since the REGISTRATION ACCEPT message was transmitted 518, and it is now acceptable for the UE 502 to begin its unavailability period, the 3GPP network 504 (e.g., the network server 506) may include, in a response to the third message transmitted at 708 (e.g., in a fourth message, such as a SERVICE ACCEPT message), an acceptance of the unavailability period. The fourth message may include, for example, a Release Request indication, a Paging Restriction indication (indicating that all paging is restricted), and an Expected Leaving Duration.

At 710, and without finishing the backoff timer, the UE 502 may begin the unavailability period and perform the operation that it previously determined to perform at 514. Contemporaneously, and at 712, the 3GPP network 504 (e.g., the network server 506) may apply a timer for the Expected Leaving Duration. The UE 502 and 3GPP network 504 may then continue with operations 524 and 526, as described with reference to FIG. 5.

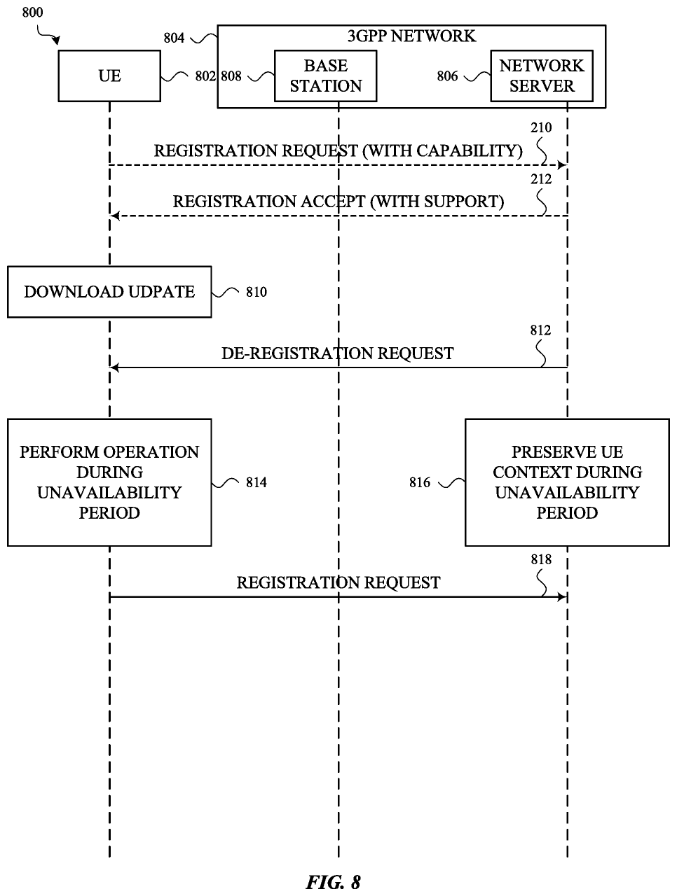

FIG. 8 illustrates an example flow diagram 800 for seamless UE context recovery when a 3GPP network 804 initiates de-registration of a UE 802. The messages shown in FIG. 8 may in some cases be transmitted as NAS messages, and may be transmitted between the UE 802 and a network server 806 of the 3GPP network 804 (e.g., a network server hosting an AMF of a CN). The messages may be transmitted between the UE 802 and the network server 806 via a base station 808 (e.g., an eNB or gNB). The operations performed by the UE 802 may be performed by a processor of the UE 802, and the transmissions and receptions of the UE 802 may be made via a transceiver of the UE 802. The operations performed by the 3GPP network 804 may be performed by a processor of the network server 806, and the transmissions and receptions of the network server 806 may be made via a communications interface of the network server 806.

The operations at 210 and 212 may be similar to those described with reference to FIG. 2.

At 810, the UE 802 may download at least one of a firmware update or a software update. The update may be downloaded from the 3GPP network 804 or over another wireless or wired network. The 3GPP network 804 may coordinate the download, be aware of the download, or may be informed of the download.

At 812, the 3GPP network 804 (e.g., the network server 806) may transmit a DEREGISTRATION REQUEST message to the UE 802. The DEREGISTRATION REQUEST message may indicate that the UE 802 is to de-register from the 3GPP network 804 and install the firmware update or the software update during an unavailability period of the UE 802. In some cases, the DEREGISTRATION REQUEST message may include an indication that re-registration is required. In some cases, the DEREGISTRATION REQUEST message may indicate a reason for the de-registration (e.g., to perform a firmware or software update).

At 814, the UE 802 may begin the unavailability period and install the update.

At 816, and contemporaneously with the operations performed at 814, the 3GPP network 804 (e.g., the network server 806) may apply a timer for the estimated duration of the unavailability period. While applying the timer, the 3GPP network 804 may preserve a context of the UE 802 (e.g., stop data transmission to the UE 802, discard pending data, hold pages, and so on). After (or within) application of the timer, the 3GPP network 804 may expect the UE 802 to transmit (and may monitor for at 818) a REGISTRATION REQUEST message indicating that the UE 802 has finished installing the update. If such a message is received by the 3GPP network 804 (e.g., by the network server 806) within the unavailability period, or within a predetermined period of time after the unavailability period, the UE 802 may seamlessly recover its context with the 3GPP network 804. If such a message is not received by the 3GPP network 804 within the unavailability period, or within a predetermined period of time after the unavailability period, the 3GPP network 804 may discard the UE's context.

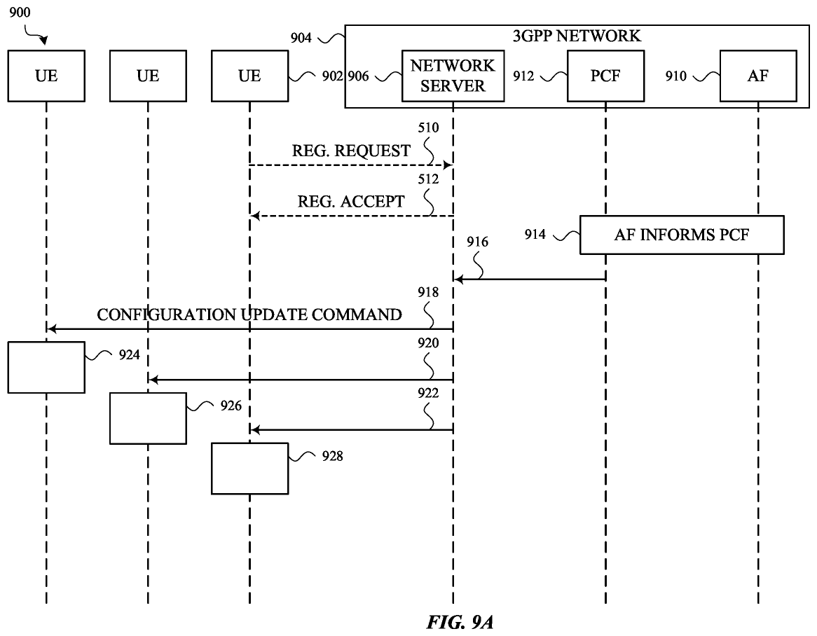

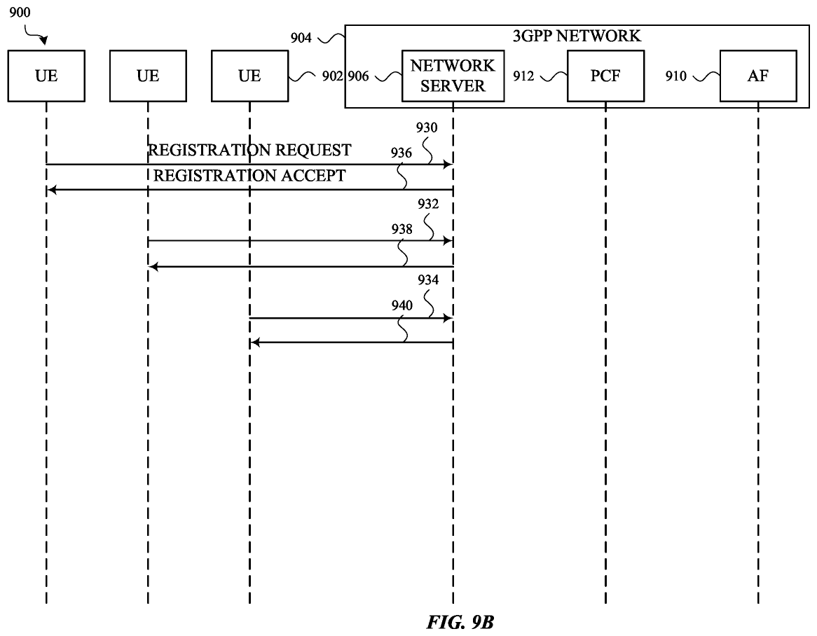

FIGS. 9A and 9B illustrate an example flow diagram 900 for seamless UE context recovery for multiple UEs. The messages shown in FIGS. 9A and 9B may in some cases be transmitted as NAS messages, and may be transmitted between a set of UEs (including a UE 902) and a network server 906 of the 3GPP network 904 (e.g., a network server hosting an AMF of a CN). The messages may be transmitted between the UEs and the network server 906 via a base station (e.g., an eNB or gNB). The operations performed by the UEs may be performed by respective processors of the UEs, and the transmissions and receptions of the UEs may be made via respective transceivers of the UEs. The operations performed by the 3GPP network 904 may be performed by a processor of the network server 906, and the transmissions and receptions of the network server 906 may be made via a communications interface of the network server 906.

The operations at 510 and 512 may be similar to those described with reference to FIG. 5 and may be performed for the UE 902 and other UEs in the set of UEs.

The operations at 914-934 presume that the UEs have downloaded at least one of a firmware update or a software update. The update may be downloaded from the 3GPP network 904 or over another wireless or wired network. The 3GPP network 904 may coordinate the download, be aware of the download, or may be informed of the download.

At 914, an AF 910 may inform a Policy Control Function (PCF) 912 of the 3GPP network 904 (e.g., via a Network Exposure Function (NEF) of the 3GPP network 904) of the identities of the UEs and the times when different UEs are scheduled to install the firmware or software update. Different UEs may be scheduled to install the update at different times, though some UEs (e.g., a subset of UEs) may be scheduled to install the update at the same time.

At 916, the PCF 912 may notify the network server 906 (e.g., an AMF) of the set of UEs and their install times.

At each of 918, 920, 922, and so on, the network server 906 may transmit a CONFIGURATION UPDATE COMMAND to a respective one of the UEs. For example, the network server 906 may transmit a CONFIGURATION UPDATE COMMAND to the UE 902 at 922. Different CONFIGURATION UPDATE COMMANDS may be transmitted at different times. Transmission of CONFIGURATION UPDATE COMMANDS at different times can prevent a “signal storm,” in which multiple UEs may perform the update at the same time and try to re-register with the 3GPP network 904 at or about the same time. Transmission of the CONFIGURATION UPDATE COMMANDS at different times can also mitigate the chance that all (or a large quantity) of the UEs became unavailable to the 3GPP network 904 at or about the same time. After transmitting a CONFIGURATION UPDATE COMMAND to a UE, the network server 906 may preserve the context of the UE for an expected duration of an unavailability period of the UE.

At 924, 926, 928, and so on, each of the UEs will install the update while the 3GPP network 904 (e.g., the network server 906) preserves the UEs' context.

At each of 930, 932, 934, and so on, a respective UE may transmit a REGISTRATION REQUEST message to the 3GPP network (e.g., to the network server 906) after completing an install of the firmware update or software update. Because the timings of the CONFIGURATION UPDATE COMMANDS transmitted at 918, 920, and 922 are staggered, the 3GPP network's receipt of the REGISTRATION REQUEST messages at 930, 932, and 934 will likely be staggered. The 3GPP network 904 (e.g., the network server 906) may respond to each REGISTRATION REQUEST message with a REGISTRATION ACCEPT message at 936, 938, 940, and so on.

The flow of the flow diagram 900 may be particularly suitable for IoT devices, which may not have any sort of smart processing functions. The flow may help conserve the power of IoT or other power-limited devices, in that it may mitigate the chance that a UE experiences a Random Access Channel (RACH) failure due to the congestion created by a signal storm as many UEs finish a firmware or software update at the same time and contemporaneously transmit REGISTRATION REQUEST messages to the 3GPP network 904.

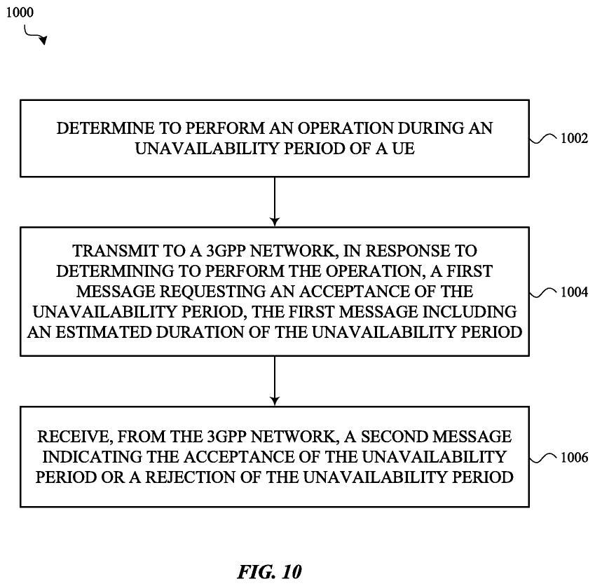

FIG. 10 shows an example method 1000 of wireless communication by a UE, which method 1000 may be used to preserve a context of the UE during an unavailability period of the UE.

At 1002, the method 1000 may include determining to perform an operation during an unavailability period of the UE.

At 1004, the method 1000 may include transmitting to a 3GPP network, in response to determining to perform the operation, a first message requesting an acceptance of the unavailability period. The first message may include an estimated duration of the unavailability period, as described, for example, with reference to FIGS. 1-7.

At 1006, the method 1000 may include receiving, from the 3GPP network, a second message indicating the acceptance of the unavailability period or a rejection of the unavailability period.

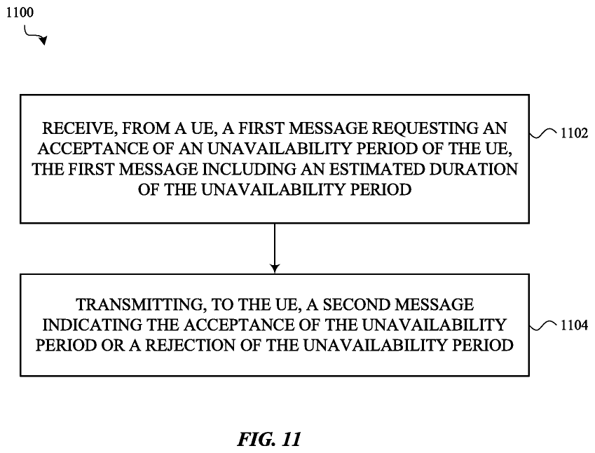

FIG. 11 shows an example method 1100 of communication by a network server, which method 1100 may be used to preserve a context of a UE during an unavailability period of the UE.

At 1102, the method 1100 may include receiving, from a UE, a first message requesting an acceptance of an unavailability period of the UE. The first message may include an estimated duration of the unavailability period, as described, for example, with reference to FIGS. 1-7.

At 1104, the method 1100 may include transmitting, to the UE, a second message indicating the acceptance of the unavailability period or a rejection of the unavailability period.

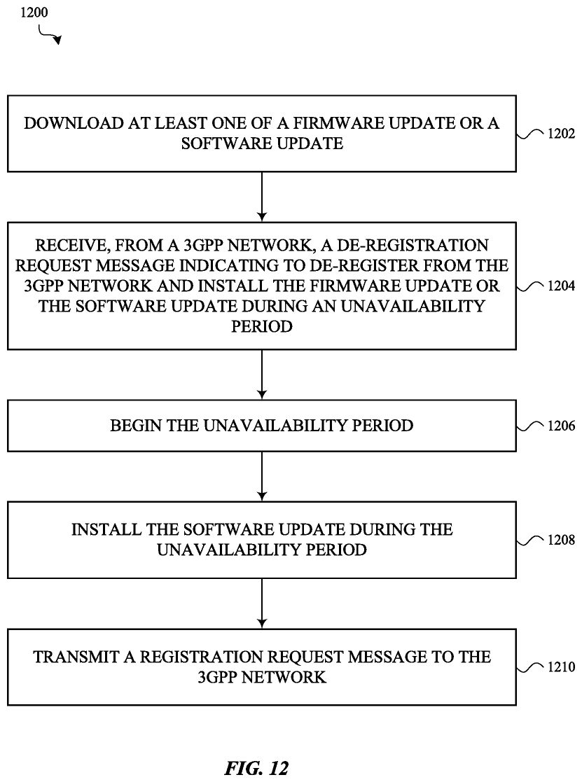

FIG. 12 shows another example method 1200 of wireless communication by a UE, which method 1200 may be used to preserve a context of the UE during an unavailability period of the UE.

At 1202, the method 1200 may include downloading at least one of a firmware update or a software update.

At 1204, the method 1200 may include receiving from a 3GPP network, after downloading the software update, a DEREGISTRATION REQUEST message indicating the UE is to de-register from the 3GPP network and install the firmware update or the software update during an unavailability period of the UE.

At 1206, the method 1200 may include beginning the unavailability period after receiving the message indicating the UE is to de-register from the 3GPP network.

At 1208, the method 1200 may include installing the software update during the unavailability period.

At 1210, the method 1200 may include transmitting a REGISTRATION REQUEST message to the 3GPP network after installing the software update.

Embodiments contemplated herein include an apparatus having means to perform one or more elements of the flow diagram 100, 200, 300, 400, 500, 600, 700, 800, or 900, or the method 1000, 1100, or 1200. This apparatus may be, for example, an apparatus of a UE (such as a wireless device that is a UE, as described herein). Alternatively, this apparatus may be, for example, an apparatus of a CN (such as a network device of a CN (e.g., an AMF), as described herein).

Embodiments contemplated herein include one or more non-transitory computer-readable media storing instructions to cause an electronic device, upon execution of the instructions by one or more processors of the electronic device, to perform one or more elements of the flow diagram 100, 200, 300, 400, 500, 600, 700, 800, or 900, or the method 1000, 1100, or 1200. This non-transitory computer-readable media may be, for example, a memory of a UE (such as a memory of a wireless device that is a UE, as described herein). Alternatively, this non-transitory computer-readable media may be, for example, a memory of a CN (such as a memory of a network device of a CN (e.g., an AMF), as described herein).

Embodiments contemplated herein include an apparatus having logic, modules, or circuitry to perform one or more elements of the flow diagram 100, 200, 300, 400, 500, 600, 700, 800, or 900, or the method 1000, 1100, or 1200. This apparatus may be, for example, an apparatus of a UE (such as a wireless device that is a UE, as described herein). Alternatively, this apparatus may be, for example, an apparatus of a CN (such as a network device of a CN (e.g., an AMF), as described herein).

Embodiments contemplated herein include an apparatus having one or more processors and one or more computer-readable media, using or storing instructions that, when executed by the one or more processors, cause the one or more processors to perform one or more elements of the flow diagram 100, 200, 300, 400, 500, 600, 700, 800, or 900, or the method 1000, 1100, or 1200. This apparatus may be, for example, an apparatus of a UE (such as a wireless device that is a UE, as described herein). Alternatively, this apparatus may be, for example, an apparatus of a CN (such as a network device of a CN (e.g., an AMF), as described herein).

Embodiments contemplated herein include a signal as described in or related to one or more elements of the flow diagram 100, 200, 300, 400, 500, 600, 700, 800, or 900, or the method 1000, 1100, or 1200.

Embodiments contemplated herein include a computer program or computer program product having instructions, wherein execution of the program by a processor causes the processor to carry out one or more elements of the flow diagram 100, 200, 300, 400, 500, 600, 700, 800, or 900, or the method 1000, 1100, or 1200. The processor may be a processor of a UE (such as a processor(s) of a wireless device that is a UE, as described herein), and the instructions may be, for example, located in the processor and/or on a memory of the UE (such as a memory of a wireless device that is a UE, as described herein). Alternatively, the processor may be a processor of a CN (such as a processor(s) of a network device of a CN (e.g., an AMF), as described herein), and the instructions may be, for example, located in the processor and/or on a memory of the CN (such as a memory of a network device of a CN (e.g., an AMF), as described herein).

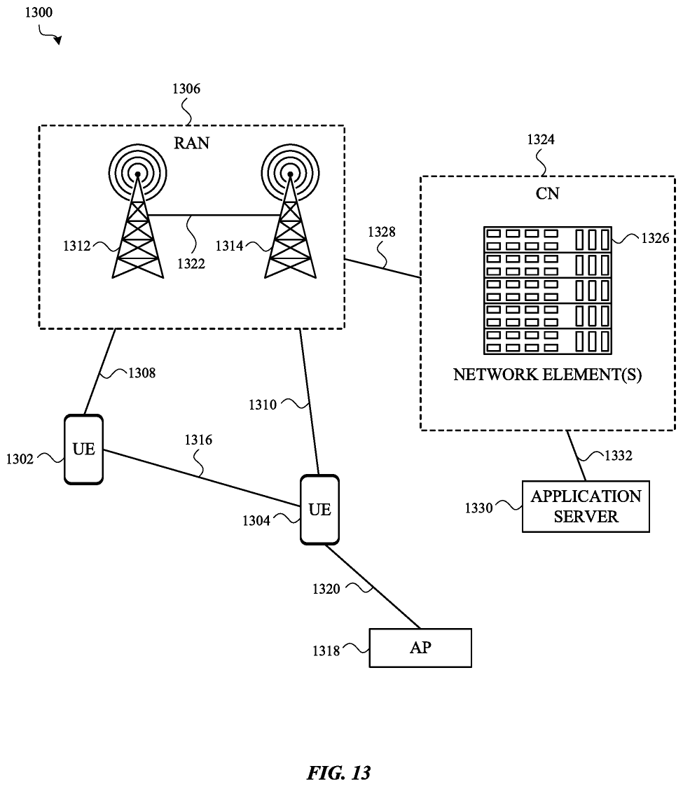

FIG. 13 illustrates an example architecture of a wireless communication system 1300 according to embodiments disclosed herein. The following description is provided for an example wireless communication system 1300 that operates in conjunction with the 4G or LTE system standards and/or 5G or NR system standards as provided by 3GPP technical specifications.

As shown by FIG. 13, the wireless communication system 1300 includes UE 1302 and UE 1304 (although any number of UEs may be used). In this example, the UE 1302 and the UE 1304 are illustrated as smartphones (e.g., handheld touchscreen mobile computing devices connectable to one or more cellular networks), but may also comprise any mobile or non-mobile computing device configured for wireless communication.

The UE 1302 and UE 1304 may be configured to communicatively couple with a RAN 1306. In embodiments, the RAN 1306 may be NG-RAN, E-UTRAN, etc. The UE 1302 and UE 1304 utilize connections (or channels) (shown as connection 1308 and connection 1310, respectively) with the RAN 1306, each of which comprises a physical communications interface. The RAN 1306 can include one or more base stations, such as base station 1312 and base station 1314, that enable the connection 1308 and connection 1310.

In this example, the connection 1308 and connection 1310 are air interfaces to enable such communicative coupling, and may be consistent with RAT(s) used by the RAN 1306, such as, for example, an LTE and/or NR.

In some embodiments, the UE 1302 and UE 1304 may also directly exchange communication data via a sidelink interface 1316. The UE 1304 is shown to be configured to access an access point (shown as AP 1318) via connection 1320. By way of example, the connection 1320 can comprise a local wireless connection, such as a connection consistent with any IEEE 802.11 protocol, wherein the AP 1318 may comprise a Wi-Fi® router. In this example, the AP 1318 may be connected to another network (for example, the Internet) without going through a CN 1324.

In embodiments, the UE 1302 and UE 1304 can be configured to communicate using orthogonal frequency division multiplexing (OFDM) communication signals with each other or with the base station 1312 and/or the base station 1314 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 1312 or base station 1314 may be implemented as one or more software entities running on server computers as part of a virtual network. In addition, or in other embodiments, the base station 1312 or base station 1314 may be configured to communicate with one another via interface 1322. In embodiments where the wireless communication system 1300 is an LTE system (e.g., when the CN 1324 is an EPC), the interface 1322 may be an X2 interface. The X2 interface may be defined between two or more base stations (e.g., two or more eNBs and the like) that connect to an EPC, and/or between two eNBs connecting to the EPC. In embodiments where the wireless communication system 1300 is an NR system (e.g., when CN 1324 is a 5GC), the interface 1322 may be an Xn interface. The Xn interface is defined between two or more base stations (e.g., two or more gNBs and the like) that connect to 5GC, between a base station 1312 (e.g., a gNB) connecting to 5GC and an eNB, and/or between two eNBs connecting to 5GC (e.g., CN 1324).

The RAN 1306 is shown to be communicatively coupled to the CN 1324. The CN 1324 may comprise one or more network elements 1326, including one or more AMFs, which are configured to offer various data and telecommunications services to customers/subscribers (e.g., users of UE 1302 and UE 1304) who are connected to the CN 1324 via the RAN 1306. The components of the CN 1324 may be implemented in one physical device or separate physical devices including components to read and execute instructions from a machine-readable or computer-readable medium (e.g., a non-transitory machine-readable storage medium).

In embodiments, the CN 1324 may be an EPC, and the RAN 1306 may be connected with the CN 1324 via an S1 interface 1328. In embodiments, the S1 interface 1328 may be split into two parts, an S1 user plane (S1-U) interface, which carries traffic data between the base station 1312 or base station 1314 and a serving gateway (S-GW), and the S1-MME interface, which is a signaling interface between the base station 1312 or base station 1314 and mobility management entities (MMEs).

In embodiments, the CN 1324 may be a 5GC, and the RAN 1306 may be connected with the CN 1324 via an NG interface 1328. In embodiments, the NG interface 1328 may be split into two parts, an NG user plane (NG-U) interface, which carries traffic data between the base station 1312 or base station 1314 and a user plane function (UPF), and the S1 control plane (NG-C) interface, which is a signaling interface between the base station 1312 or base station 1314 and AMFs.

Generally, an application server 1330 may be an element offering applications that use internet protocol (IP) bearer resources with the CN 1324 (e.g., packet switched data services). The application server 1330 can also be configured to support one or more communication services (e.g., VoIP sessions, group communication sessions, etc.) for the UE 1302 and UE 1304 via the CN 1324. The application server 1330 may communicate with the CN 1324 through an IP communications interface 1332.

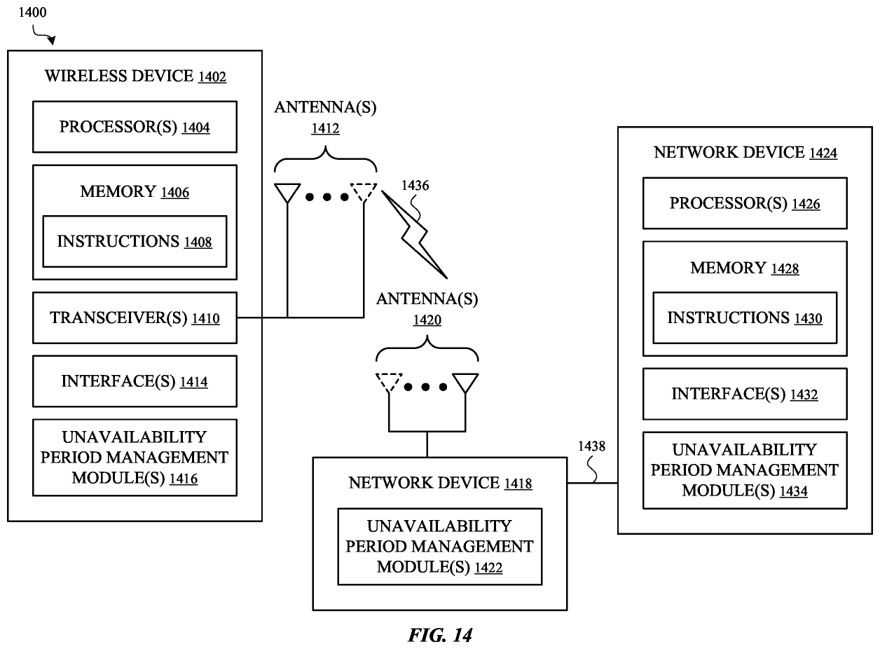

FIG. 14 illustrates a system 1400 for performing signaling 1436, 1438 between a wireless device 1402 and one or more network devices 1418, 1424, according to embodiments disclosed herein. The system 1400 may be a portion of a wireless communications system as herein described. The wireless device 1402 may be, for example, a UE of a wireless communication system. The network devices 1418, 1424 may include, for example, a base station (e.g., a gNB) and an AMF of a wireless communication system.

The wireless device 1402 may include one or more processor(s) 1404. The processor(s) 1404 may execute instructions such that various operations of the wireless device 1402 are performed, as described herein. The processor(s) 1404 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1402 may include a memory 1406. The memory 1406 may be a non-transitory computer-readable storage medium that stores instructions 1408 (which may include, for example, the instructions being executed by the processor(s) 1404). The instructions 1408 may also be referred to as program code or a computer program. The memory 1406 may also store data used by, and results computed by, the processor(s) 1404.

The wireless device 1402 may include one or more transceiver(s) 1410 that may include radio frequency (RF) transmitter and/or receiver circuitry that use the antenna(s) 1412 of the wireless device 1402 to facilitate signaling (e.g., the signaling 1436) to and/or from the wireless device 1402 with other devices (e.g., the network device 1418) according to corresponding RATs.

The wireless device 1402 may include one or more antenna(s) 1412 (e.g., one, two, four, or more). For embodiments with multiple antenna(s) 1412, the wireless device 1402 may leverage the spatial diversity of such multiple antenna(s) 1412 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1402 may be accomplished according to precoding (or digital beamforming) that is applied at the wireless device 1402 that multiplexes the data streams across the antenna(s) 1412 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1402 may implement analog beamforming techniques, whereby phases of the signals sent by the antenna(s) 1412 are relatively adjusted such that the (joint) transmission of the antenna(s) 1412 can be directed (this is sometimes referred to as beam steering).

The wireless device 1402 may include one or more interface(s) 1414. The interface(s) 1414 may be used to provide input to or output from the wireless device 1402. For example, a wireless device 1402 that is a UE may include interface(s) 1414 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 1410/antenna(s) 1412 already described) that allow for communication between the UE and other devices and may operate according to known protocols (e.g., Wi-Fi®, Bluetooth®, and the like).

The wireless device 1402 may include an unavailability period management module 1416. The unavailability period management module 1416 may be implemented via hardware, software, or a combination thereof. For example, the unavailability period management module 1416 may be implemented as a processor, circuit, and/or instructions 1408 stored in the memory 1406 and executed by the processor(s) 1404. In some examples, the unavailability period management module 1416 may be integrated within the processor(s) 1404 and/or the transceiver(s) 1410. For example, the unavailability period management module 1416 may be implemented by a combination of software components (e.g., executed by a DSP or a general processor) and hardware components (e.g., logic gates and circuitry) within the processor(s) 1404 or the transceiver(s) 1410.

The unavailability period management module 1416 may be used for various aspects of the present disclosure, for example, aspects of FIGS. 1-12. The unavailability period management module 1416 may be configured to, for example, determine or manage an unavailability period of the wireless device 1402 as described herein.

The network device 1418 may also include one or more processor(s). The processor(s) may execute instructions such that various operations of the network device 1418 are performed, as described herein. The processor(s) may include one or more baseband processors implemented using, for example, a CPU, a DSP, an ASIC, a controller, an FPGA device, another hardware device, a firmware device, or any combination thereof configured to perform the operations described herein.

The network device 1418 may include a memory. The memory may be a non-transitory computer-readable storage medium that stores instructions (which may include, for example, the instructions being executed by the processor(s)). The instructions may also be referred to as program code or a computer program. The memory may also store data used by, and results computed by, the processor(s).

The network device 1418 may include one or more transceiver(s) that may include RF transmitter and/or receiver circuitry that use the antenna(s) 1420 of the network device 1418 to facilitate signaling (e.g., the signaling 1436) to and/or from the network device 1418 with other devices (e.g., the wireless device 1402) according to corresponding RATs.

The network device 1418 may include one or more antenna(s) 1420 (e.g., one, two, four, or more). In embodiments having multiple antenna(s) 1420, the network device 1418 may perform MIMO, digital beamforming, analog beamforming, beam steering, etc., as has been described.

The network device 1418 may include one or more interface(s). The interface(s) may be used to provide input to or output from the network device 1418. For example, a network device 1418 that is a base station may include interface(s) made up of transmitters, receivers, and other circuitry (e.g., other than the transceiver(s)/antenna(s) 1420 already described) that enables the base station to communicate with other equipment (e.g., the network device 1424) in a core network, and/or that enables the base station to communicate with external networks, computers, databases, and the like for purposes of operations, administration, and maintenance of the base station or other equipment operably connected thereto.

The network device 1418 may include an unavailability period management module 1422. The unavailability period management module 1422 may be implemented via hardware, software, or a combination thereof. For example, the unavailability period management module 1422 may be implemented as a processor, circuit, and/or instructions stored in the memory and executed by the processor(s). In some examples, the unavailability period management module 1422 may be integrated within the processor(s) and/or the transceiver(s). For example, the unavailability period management module 1422 may be implemented by a combination of software components (e.g., executed by a DSP or a general processor) and hardware components (e.g., logic gates and circuitry) within the processor(s) or the transceiver(s).

The unavailability period management module 1422 may be used for various aspects of the present disclosure, for example, aspects of FIGS. 1-12. The unavailability period management module 1422 may be configured to, for example, determine or manage an unavailability period of the wireless device 1402 as described herein.

The network device 1424 may also include one or more processor(s) 1426. The processor(s) 1426 may execute instructions 1430 such that various operations of the network device 1424 are performed, as described herein. The processor(s) 1426 may include one or more processors implemented using, for example, a CPU, a DSP, an ASIC, a controller, an FPGA device, another hardware device, a firmware device, or any combination thereof configured to perform the operations described herein.

The network device 1424 may include a memory 1428. The memory 1428 may be a non-transitory computer-readable storage medium that stores instructions 1430 (which may include, for example, the instructions being executed by the processor(s) 1426). The instructions 1430 may also be referred to as program code or a computer program. The memory 1428 may also store data used by, and results computed by, the processor(s) 1426.

The network device 1424 may include one or more interface(s) 1432. The interface(s) 1432 may be used to provide input to or output from the network device 1418. For example, a network device 1424 that is an AMF of a core network may include interface(s) made up of transmitters, receivers, and other circuitry that enables the AMF to communicate with other equipment (e.g., the network device 1418 via signaling 1438, or the wireless device 1402 via signaling 1438 and the network device 1418), and/or that enables the AMF to communicate with external networks, computers, databases, and the like for purposes of operations, administration, and maintenance of the AMF or other equipment operably connected thereto.

The network device 1424 may include an unavailability period management module 1434. The unavailability period management module 1434 may be implemented via hardware, software, or a combination thereof. For example, the unavailability period management module 1434 may be implemented as a processor, circuit, and/or instructions 1430 stored in the memory 1428 and executed by the processor(s) 1426. In some examples, the unavailability period management module 1434 may be integrated within the processor(s) 1426. For example, the unavailability period management module 1434 may be implemented by a combination of software components (e.g., executed by a DSP or a general processor) and hardware components (e.g., logic gates and circuitry) within the processor(s) 1426.

The unavailability period management module 1434 may be used for various aspects of the present disclosure, for example, aspects of FIGS. 1-12. The unavailability period management module 1434 may be configured to, for example, determine or manage an unavailability period of the wireless device 1402 as described herein.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A user equipment (UE), comprising:
a transceiver; and
a processor configured to,
determine to perform an operation during an unavailability period of the UE;
transmit to a 3rd Generation Partnership Project (3GPP) network, in response to determining to perform the operation and via the transceiver, a first message requesting an acceptance of the unavailability period, the first message including an estimated duration of the unavailability period; and
receive from the 3GPP network, via the transceiver, a second message indicating the acceptance of the unavailability period or a rejection of the unavailability period.

2. The UE of claim 1, wherein:
the processor is configured to, prior to transmitting the first message,
transmit to the 3GPP network, in a 5G mobility management (5GMM) capability information element (IE) of a REGISTRATION REQUEST message and via the transceiver, an indication of a capability to determine the unavailability period; and
receive from the 3GPP network, in a 5G system (5GS) network feature support IE of a REGISTRATION ACCEPT message and via the transceiver, an indication of support for the capability to determine the unavailability period.

3. The UE of claim 1, wherein:
the first message is a REGISTRATION REQUEST message, and the estimated duration of the unavailability period is included in a first information element (IE) of the REGISTRATION REQUEST message; and
the second message is a REGISTRATION ACCEPT message including a second IE indicating the acceptance or the rejection of the unavailability period.

4. The UE of claim 1, wherein:
the second message indicates the unavailability period is accepted; and
the processor is configured to, in response to the unavailability period being accepted,
begin the unavailability period; and
perform the operation during the unavailability period.

5. The UE of claim 4, wherein:
the processor is configured to, in response to the unavailability period being accepted,
transmit a DEREGISTRATION REQUEST message to the 3GPP network, via the transceiver, before beginning the unavailability period; and
transmit a REGISTRATION REQUEST message to the 3GPP network, via the transceiver, after performing the operation.

6. The UE of claim 5, wherein the DEREGISTRATION REQUEST message includes a cause or a type of de-registration.

7. The UE of claim 4, wherein:
the processor is configured to,
transmit a REGISTRATION REQUEST message or a SERVICE REQUEST message to the 3GPP network, via the transceiver, after performing the operation.

8. The UE of claim 1, wherein:
the second message references a backoff timer; and
the processor is configured to,
start the backoff timer; and
after finishing the backoff timer,
transmit a DEREGISTRATION REQUEST message to the 3GPP network via the transceiver;
receive a DEREGISTRATION ACCEPT message from the 3GPP network, in response to transmitting the DEREGISTRATION REQUEST message;
begin the unavailability period after receiving the DEREGISTRATION ACCEPT message;
perform the operation during the unavailability period; and
transmit a REGISTRATION REQUEST message to the 3GPP network, via the transceiver, after performing the operation.

9. The UE of claim 1, wherein:
the second message references a backoff timer; and
the processor is configured to,
start the backoff timer;
transmit a third message to the 3GPP network, via the transceiver, after starting the backoff timer and before finishing the backoff timer;
receive from the 3GPP network, in response to the third message and via the transceiver, a fourth message including the acceptance of the unavailability period; and
in response to the unavailability period being accepted,
begin the unavailability period; and
perform the operation during the unavailability period.

10. The UE of claim 1, wherein:
the second message indicates the unavailability period is rejected; and
the processor is configured to,
transmit to the 3GPP network, after receiving the second message and via the transceiver, a third message requesting the acceptance of the unavailability period, the third message including the estimated duration of the unavailability period; and
receive from the 3GPP network, via the transceiver, a fourth message including the acceptance or the rejection of the unavailability period.

11. The UE of claim 1, wherein:
the processor is configured to, prior to transmitting the first message,
transmit to the 3GPP network, in a 5G mobility management (5GMM) core network capability information element (IE) of a REGISTRATION REQUEST message and via the transceiver, an indication of a capability to support a Multiple Universal Subscriber Identity Modules (MUSIM) Connection Release, a MUSIM Paging Restriction, and the estimated duration of the unavailability period; and
receive from the 3GPP network, in a REGISTRATION ACCEPT message and via the transceiver, an indication of support for the MUSIM Connection Release, the MUSIM Paging Restriction, and the estimated duration of the unavailability period.

12. The UE of claim 1, wherein:
the first message is a REGISTRATION REQUEST message or a SERVICE REQUEST message, and the first message further includes a Release Request indication and a Paging Restriction indication; and
the second message is a REGISTRATION ACCEPT message or a SERVICE ACCEPT message including the acceptance or the rejection of the unavailability period.

13. The UE of claim 1, wherein:
the second message references a backoff timer; and
the processor is configured to,
start the backoff timer;
after finishing the backoff timer,
begin the unavailability period;
perform the operation during the unavailability period; and
transmit a REGISTRATION REQUEST message or a SERVICE REQUEST message to the 3GPP network, via the transceiver, after performing the operation.

14. The UE of claim 1, wherein the operation includes at least one of a firmware update or a software update.

15. A user equipment (UE), comprising:
a transceiver; and
a processor configured to,
download at least one of a firmware update or a software update;
receive from a 3rd Generation Partnership Project (3GPP) network, after downloading the software update and via the transceiver, a DEREGISTRATION REQUEST message indicating the UE is to de-register from the 3GPP network and install the firmware update or the software update during an unavailability period of the UE;
begin the unavailability period after receiving the message indicating the UE is to de-register from the 3GPP network;
install the software update during the unavailability period; and
transmit a REGISTRATION REQUEST message to the 3GPP network, via the transceiver, after installing the software update.

16. A network server, comprising:
a communications interface; and
a processor configured to,
receive from a user equipment (UE), via the communications interface, a first message requesting an acceptance of an unavailability period of the UE, the first message including an estimated duration of the unavailability period; and
transmit to the UE, via the communications interface, a second message indicating the acceptance of the unavailability period or a rejection of the unavailability period.

17. The network server of claim 16, wherein:
the processor is configured to, prior to receiving the first message,
receive from the UE, in a 5G mobility management (5GMM) capability information element (IE) of a REGISTRATION REQUEST message and via the communications interface, an indication of a capability to determine the unavailability period; and
transmit to the UE, in a 5G system (5GS) network feature support IE of a REGISTRATION ACCEPT message and via the communications interface, an indication of support for the capability to determine the unavailability period.

18. The network server of claim 16, wherein:
the second message references a backoff timer; and
the processor is configured to,
start the backoff timer;
after finishing the backoff timer, receive a DEREGISTRATION REQUEST message from the UE via the communications interface; and
after receiving the DEREGISTRATION REQUEST message,
start a timer for the estimated duration of the unavailability period; and
preserve a context of the UE; and
after finishing the timer for the estimated duration of the unavailability period, monitor for a REGISTRATION REQUEST message from the UE.

19. The network server of claim 16, wherein:
the second message references a backoff timer; and
the processor is configured to,
start the backoff timer;
after finishing the backoff timer,
start a timer for the estimated duration of the unavailability period; and
preserve a context of the UE and restrict paging of the UE; and
after finishing the timer for the estimated duration of the unavailability period, monitor for a REGISTRATION REQUEST message or a SERVICE REQUEST message from the UE.

20. The network server of claim 19, wherein:
the processor is configured to,
restore the context of the UE upon receiving the REGISTRATION REQUEST message or the SERVICE REQUEST message, and otherwise delete the context of the UE.
